(19) United States
(12) Patent Application Publication
(10) Pub. No.: US 2021/0114934 A1
(43) Pub. Date: Apr. 22, 2021

(54) MOLDABLE COMPOSITE MATERIAL

(71) Applicant: AIMEE SUMTER COLLINS, WIMBERLEY, TX (US)

(72) Inventor: AIMEE SUMTER COLLINS, WIMBERLEY, TX (US)

(21) Appl. No.: 16/655,487

(22) Filed: Oct. 17, 2019

(51) Int. Cl. C04B 33/04; B33Y 70/00; C08L 97/02; C04B 33/13; C04B 33/18

(52) U.S. Cl. CPC C04B 33/04; B33Y 70/00; C08L 97/02; C04B 33/1305; C04B 2235/48; C04B 33/18; C08L 2205/06; C04B 2235/349; C04B 33/1315

(57) ABSTRACT

A moldable composite material for use in the production of models and objects across numerous industries, the cured state of the composite material having various other applications, and a method of manufacture thereof. The composite material is self-adhering, substantially self-curing, and easily recyclable for reclamation of reuse. Certain embodiments may also be applied for use in 3D printing.

### BACKGROUND OF THE INVENTION

The present invention relates generally to a composite material for use in the manufacture or modification of various physical articles, objects, or products. Such material may also have properties that render it suitable for use as insulation or in the form of an injectable or dispensable paste.

There is a current need for such a versatile, reusable component material across many industries (including aerospace engineering, visual arts, and 3D printing) that are investing heavily in the development of advanced materials to assist in cutting future costs and minimizing the environmental footprint of their respective endeavors.

Conventional materials used in these industries typically involve a degree of complexity, tedium, and time commitment (from acquisition and preparation of constituent ingredients through prototyping, manufacture, and any subsequent revisionary work) that result in tremendous cost and waste. In some instances, specialized processes or equipment operated by skilled technicians are required simply to produce the component materials.

In the realm of these known techniques, conventional materials often rely on a minimum of 2-part components (such as 2-part epoxies or concrete) combined in some manner immediately prior to use to be effective in modelling, building, or modifying an object. These conventional materials often have a short shelf-life and working window once combined as they generally dry, or cure, quickly and become unsuitable for molding or shaping. This property substantially limits the type and detail level of objects made with these materials. By contrast, embodiments of the present invention are materials that rely on a “one-part” component and that are ready to use without requiring any extensive processing immediately prior to such use as in the prior art.

Many conventional materials require further manipulation (such as combination with plastics, resins, metal powders, binding agents, or application of heat) to facilitate the modeling of the materials or the securing of such materials to a base underlying structure. These prior art methodologies require specialized tools and use of various disparate constituent, which must be carefully controlled (sometimes including a fixed vertical orientation to account for the effects of gravity), in order to effectively use the conventional materials to produce any object many of which are not durable and require still further processing to cure. Specifically, many current industry standard object modeling or production methods (such as those previously mentioned and those used in ceramics production) require further distinct, separate processes such as sintering, firing (including repetitive rounds of firing), or annealing, which themselves require corresponding specialized technical equipment, materials, time, and energy, to result in a fixed, durable product. Embodiments of the present invention, however, are effectively self-adhering and self-curing at room temperature when exposed to air (more specifically components of air-carbon dioxide being particularly effective) which results in a durable, solid composition without any additional steps.

Additionally, there is presently a general incompatibility between certain classes or types of conventional modeling materials (e.g. plastics, highly malleable clay-like water-based substances, and mineral- or organic-rich materials) that limits combination of such materials to even attempt to meet the growing need for more versatile modeling materials. Looking to applications of plastics in modeling, there are only a limited number of available non-plastic materials that are capable of satisfactory adherence to plastics or rubbers for the purpose of modeling, modification, or support of plastic or rubber objects. Due to the physical limitations of plastic and relative difficulty for use in modeling, a demand has grown for non-plastic materials which are water-based, malleable, and formable through simple processes that also adhere to plastic and that are resistant to heat and electricity.

This need is strongly felt in the hobbyist modeling industry in which plastic model kits are very common. There has been very little, if any progress, in developing materials suitable for this type of sculpting with, or otherwise modifying, plastic models despite the longstanding popularity and profitability of hobby modeling. Conventional practice utilizes 2-part epoxies, aquarium repair compounds, or other such substances to supplement the deficiencies of existing modeling materials. These substances were not designed or intended for this use and, as described above, often prove difficult to use.

Emerging technologies and industries (including 3D printing) also face a similar lack of versatile modeling materials. From the hobbyists discussed previously to design professionals and experimental prototyping, many are turning to 3D-printing for its ease and efficiency in creating customized models. Developments in the 3D-printing field seem to presently focus efforts in highly technical and process-heavy experimental materials with special attention given to the incorporation of resins, metal powders and binders, photocuring, and thermodynamic plastics. Each of the disciplines currently investigated, however, suffer from a need of specialized equipment, a supply of various, disparate constituent materials, very delicate instrumentation to regulate fabrication of the materials, extensive post-modeling processing, and major investments in skilled personnel to properly utilize and practice the techniques associated with such equipment and processes.

Despite the longstanding profitability and popularity of hobby modelling, and the ongoing, and continually growing, interest and demand for 3D-printed models and/or prototyping (of which a large percentage utilize plastics), there is still need for a more cost-effective and versatile material from which these models can be produced.

### SUMMARY OF THE INVENTION

It is an object of the present invention to address each of the issues or difficulties presented by prior art materials and methodologies. In general, the present invention optimizes the efficiency, cost, and environmental impact of manufacturing and using a versatile building material for producing models and objects (or for other uses across many industries) Viable in many states (including wet, paste, or as cured) and capable of self-curing or hardening when formed into a desired structure and exposed to air or components thereof (carbon dioxide being particularly effective), the material of the present invention has superior utility as compared to those materials presently known in the art. The present invention provides for a one-part, non-toxic, non-hazardous alternative to prior art materials while simultaneously producing less waste and allowing for easy reuse.

The present invention improves the efficiency by minimizing the number of requisite constituent ingredients, eliminating the need for certain conventional processes (such as pre-mixing substances immediately prior to use), and reducing the amount equipment to perform any required processes. Rather, the present invention relies on a previously unknown combination of simple ingredients thoroughly mixed to produce a versatile, substantially self-curing building or modeling material. As a result, the present invention also avoids complications that arise from the further processing often required by prior art materials to cure—such as material loss and energy consumption during sintering or firing. The material of the present invention also improves on flexibility and ease of use when compared to prior art materials as it remains malleable as long as it is kept moist thereby allowing more time to fabricate intricate or complex designs while providing excellent storage shelf-life. Furthermore, once cured, the material of the present invention is easily recyclable and reusable by users.

Due to improved heat and electrical resistance relative to other available modeling materials, the present invention is capable of successful deployment for numerous applications across diverse industries including: as an insulation or shielding material (thermal, electrical, radiation, and/or vibrational), as feedstock or otherwise as a basic building material, in 3D Printing (or other additive manufacturing), in sculpting and modeling (or other artistic uses), in product design and prototyping (relevant to various medical fields, architecture, and the automotive and aerospace industries), as a construction material, as a coating material, in computer numerical control machining (CNC) (or other subtractive manufacturing) when cured, and any other industrial uses for which there is a need of an immediately recyclable and environmentally friendly building material or media.

The present invention additionally fulfills a need for suitable materials in the 3D printing industry while improving (or removing) the complexities or limitations of many current techniques. Unlike some prior art approaches, for example, practice of the present invention does not require any particular orientation to minimize or otherwise regulate the effects of gravity on the building material. The composite material of the present invention can be utilized in 3D-printing to process, support, control, or otherwise facilitate the manufacture of 3D-printed products.

The material of the present invention may also be used for prototyping, to manufacture and to improve, through its superior resistances and reusability, a variety of products including circuit boards or other electrical components, and serve to facilitate repair and protection of ceramic, porcelain, and plastic items.

### BRIEF DESCRIPTION OF THE DRAWINGS

FIG. 1 is a flow diagram depicting stages of creating, using, and reclaiming composite material of one embodiment of the present invention.

### DETAILED DESCRIPTION OF EMBODIMENTS OF THE INVENTION

This description, with references to the figures, presents non-limiting examples of embodiments of the present invention.

In one embodiment of the present invention, a moldable composite building material comprises an adhesive agent, a molding agent, and a solvent. The adhesive agent, molding agent, and solvent are combined until the three constituents form a homogeneous mixture. These three constituents may be combined manually, mechanically, or through any other means devised that will result in a homogeneous mixture. During the combination process, it may initially appear that the constituents are not becoming sufficiently integrated, however, continued mixing will ultimately lead to the desired homogeneous mixture.

Although a homogeneous mixture can be achieved through direct manual mixing, use of some mechanical apparatus (such as an auger, blender, grinder, or any device capable of effecting a blending or kneading action) is recommended for production of larger quantities. To expedite the mixing process, the constituent components can be alternated over time as they are fed into the mixture. When all quantities of constituents are present in the mixture, the mixture itself can be fed through a mechanical apparatus as many times as needed or be otherwise left to continue processing in the mechanical apparatus until homogeneity is reached.

In certain embodiments, the adhesive agent comprises a polymer element and at least one bonding element. Such an adhesive agent may be a commercially available wood filler (for example, those produced by Elmer's or Zar) and that contains wood-based cellulose fibers as a polymer element. The at least one bonding element can be any binders or adhesion promoters known in the art for use in such wood fillers to facilitate bonding of said wood fillers to wood. In these embodiments, the molding agent (alternatively referred to as a filler or filling agent) comprises an inorganic element. Such molding elements may be a commercially available air-dry clay (for example, those produced by Crayola, and Padico) having an inorganic mineral element. This inorganic mineral element is preferably of a similar composition to inorganic elements present in the adhesive agent. This molding/filling agent serves, in part, to provide additional texture and body to the composite material for more comfortable use. In this embodiment, the solvent may be water.

The combination of a wood filler (or a dough or putty) with an air-dry clay and water is effective in ensuring the adherence of the resulting composite material to polymers including cellulose-based polymers. By utilizing a clay having a composition of inorganic materials similar to those of the selected wood filler, the wood filler's capacity to facilitate polymer adhesion is not interfered with while the overall texture and usability of the composite material is improved. Furthermore, the resulting composite material benefits from minimized shrinking when cured.

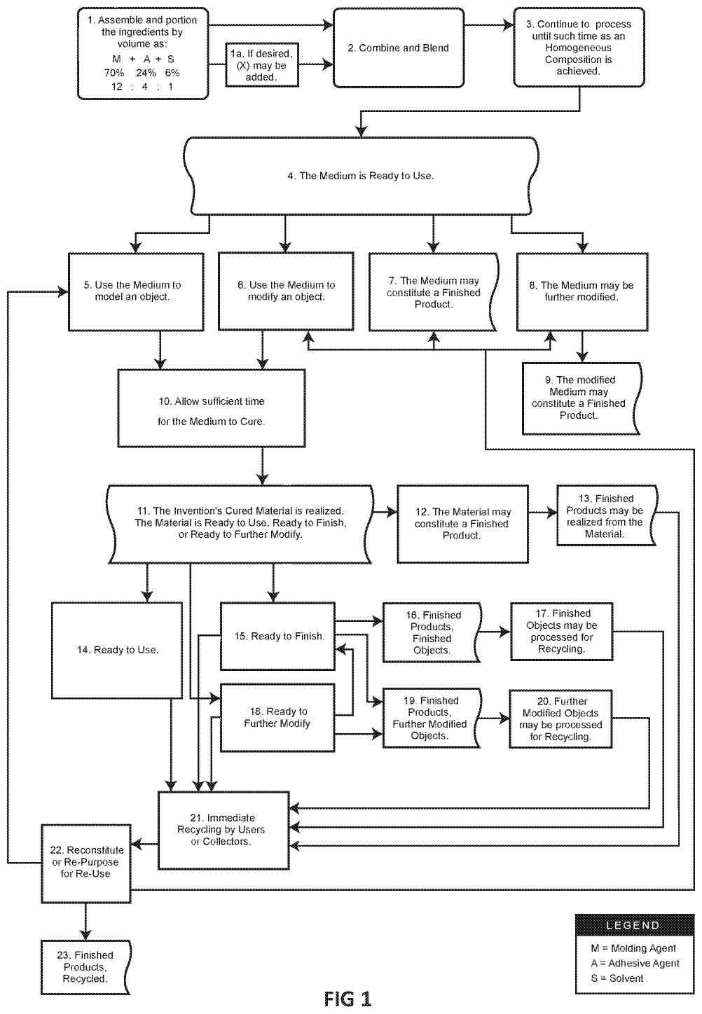

The composite material is ready to use once mixed and can be stored in a closed container for later use without a need for mixing immediately prior to use. The composite material further displays an ability to self-cure over time (as discussed previously and similar to traditional plasters and concrete) without reliance any additional external processing. As some moisture begins to leave the composite material, the chemical bonds between the adhesive and molding agents become stronger and more stable as a matrix of crystalline-like structures form. In a cured state, the composite material proves to be smooth and durable to an extent which exceeds that of the individual constituents. Additionally, the cured composite material is capable of having additional composite material adhered to it. Furthermore, the cured composite material can be destroyed or ground down (either manually or mechanically) and, through inclusion of additional solvent, caused to enter a state substantially similar to that when first created through homogeneous combination of the constituents thereby allowing for subsequent reconstitution and curing. This process of “reclaiming” the composite material will generally require introduction of, and prolonged contact with, additional solvent (oftentimes soaking the target composite material in water) until the composite material is again soft and malleable at which point further mixing and/or kneading may also be required. The various stages of the composite material, and transitions therebetween, can be seen in FIG. 1.

These self-adhering and self-curing capabilities improve drastically over the prior art which has traditionally relied on tedious pre-modeling preparation of numerous materials and external processes to achieve the same. The ability to reuse or otherwise recycle the subject composite material also affords tremendous savings to energy, materials, and time. In terms of the curing process and the effectiveness thereof, it is likely that some interaction between polyvinyl alcohols and borate catalysts is, in part, the cause along with interactions with elements of the adhesive agent.

In certain embodiments, the composite material is composed (by volume) of 24% adhesive agent, 70% molding agent, and 6% solvent. While additional additives or processing may be incorporating during production or after cure to modify various properties of the composite material, these are entirely optional and may be implemented on as needed basis per the specific requirements of a particular application as would be understood by one of ordinary skill in the art. In a wet, or raw, state, the composite material is the homogeneous mixture as described above with respect to a more general embodiment. The composite material is ready for use in this state as it is wet-stable. The composite material is non-toxic, non-hazardous, gluten-free, and does not require application or use in any specific orientation as it is stable enough to withstand the effects of gravity or possible lack thereof. The composite material of this embodiment is suitable for general modeling purposes having an exceptional malleability which allows for the capture or maintaining of intricate detail in modeled objects and a pleasant texture during handling.

This composite material may be used to modify, coat, or repair articles or objects composed of any substance to which the composite material adheres (including the composite material itself in its cured state).

As indicated previously, to reach a cured state, composite material in a wet, or raw, state should be exposed to ambient air, or components of air, for a period of time that depends, in part, on the thickness of the application of the composite material, the moisture content of the composite material, and the conditions of the ambient air or atmosphere (such as relative humidity and temperature). In cases where the thickness of the application is less than ½ inch, and the ambient conditions are sufficient to allow for the natural evaporation of water or liquid from the composite material, a cured state will typically be reached within 1 to 24 hours.

In its cured state, the composite material is durable, sturdy, and capable of various uses as previously described. Furthermore, in certain embodiments, the resultant cured material is porous. Improving over the prior art, the cured material of the present invention may be combined with a wider array of simpler finishing materials and techniques relative to many plastics presently used in modelling.

In yet other embodiments, the composite material is composed (by volume) of 23% adhesive agent, 76% molding agent, and 1% solvent. The composite material of this embodiment presents as a more elastic substance when in a wet, or raw, state as compared to previously described embodiments. In one particular embodiment, an alternative method of measurement was used wherein an 8.1-ounce amount of composite material was comprised of 4.0 oz. of adhesive agent, 4.0 oz. of molding agent, and 0.1 oz. of solvent. For production of this embodiment, and when dealing with amounts of this size, manual mixing is sufficient. Techniques similar to “taffy-pulling” in which portions of adhesive agent and molding agent are repeatedly combined, folded, twisted a few times, and pulled to a length between hands (with solvent periodically added) is effective.

Although the invention has been explained in relation to various embodiments thereof, it is to be understood that many other possible modifications and variations can be made without departing from the spirit and scope of the invention.

1. A moldable composite material comprising:
an adhesive agent;
a molding agent; and
a solvent wherein said adhesive agent, said molding agent, and said solvent are combined to form a substantially homogeneous mixture.

2. The composite material of claim 1 wherein said adhesive agent comprises a polymer binding element to facilitate adhesion to polymers.

3. The composite material of claim 1 wherein said adhesive agent is a wood filler.

4. The composite material of claim 3 wherein said molding agent is an air-dry clay.

5. The composite material of claim 4 wherein said solvent is water.
